(19) United States
(12) Patent Application Publication
(10) Pub. No.: US 2025/0249418 A1
(43) Pub. Date: Aug. 7, 2025

(54) MAGNETICALLY-COUPLED BLENDER BOTTLE SYSTEM

(71) Applicant: Mag Mixer, LLC, Wellsville, UT (US)

(72) Inventors: Daniel Mitton, Wellsville, UT (US); Brett Hadfield, Millville, UT (US)

(21) Appl. No.: 19/096,388

(22) Filed: Mar. 31, 2025

Related U.S. Application Data
(60) Provisional application No. 63/548,583, filed on Feb. 1, 2024.

(51) Int. Cl. B01F 33/453; B01F 35/41; B01F 35/50; B01F 35/75; B01F 101/14

(52) U.S. Cl. CPC B01F 33/4537; B01F 35/4111; B01F 35/50; B01F 35/751; B01F 2101/14

(57) ABSTRACT

A blender bottle system includes a bottle structure forming an inner volume. Liquid is to be disposed in the inner volume. The blender bottle system further includes a lid structure configured to releasably interface with the bottle structure. The lid structure includes a spout portion forming an opening. The blender bottle system further includes an actuation structure configured to be moved by a user relative to the bottle structure. The actuation structure includes one or more metallic components. The blender bottle system further includes an agitator structure disposed in the bottle structure. The agitator structure and the actuation structure are magnetically attracted to each other. The agitator structure is configured to mix the liquid in the bottle structure responsive to the actuation structure being moved relative to the bottle structure.

### RELATED APPLICATION

This application claims benefit of U.S. Provisional App. No. 63/548,583, filed Feb. 1, 2024, the contents of which are incorporated by reference in their entirety.

### BACKGROUND

Liquids are used for many purposes. Liquids may be consumed by people and/or animals. Liquids may be used for irrigation. Systems and/or devices may be used in conjunction with liquids. Agitation may be used in conjunction with the systems and/or devices to mix a liquid with another material (e.g., a powder, another liquid, etc.) and/or to clean one or more components.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-C illustrate blender bottle systems, according to certain embodiments.

FIGS. 2A-B illustrate blender bottle systems, according to certain embodiments.

FIGS. 3A-E illustrate components of blender bottle systems, according to certain embodiments.

FIGS. 4A-B illustrate components of blender bottle systems, according to certain embodiments.

FIGS. 5A-B illustrate perspective views of blender bottle systems 100, according to certain embodiments.

FIGS. 6A-C illustrate agitator structures of blender bottle systems, in accordance with some embodiments.

### DETAILED DESCRIPTION

The present disclosure is associated with a magnetically-coupled blender bottle system.

Liquids are used for many purposes. Liquids may be consumed by people and/or animals. Liquids may be used for irrigation. Systems and/or devices may be used in conjunction with liquids. Agitation may be used in conjunction with the systems and/or devices to mix a liquid with another material (e.g., a powder, another liquid, etc.) and/or to clean one or more components.

Liquids are consumed for various reasons. A liquid may be consumed to satisfy thirst, to obtain nutrients, for a stimulating effect, for a calming effect, in conjunction with socializing, for recreation, for taste, as a dietary supplement, as a bodybuilding supplement, to induce sleep, etc. Prior to being consumed, a liquid may be mixed with another material. For example, a powder (e.g., dietary supplement, bodybuilding supplement, milk chocolate mix, hot chocolate mix, baby formula, powdered milk, etc.) may be mixed with liquid (e.g., water, milk) prior to consumption.

Conventional solutions for mixing a liquid with another material (e.g., powder) include adding the material to the liquid and stirring with a utensil (e.g., spoon) and/or adding the material to the liquid in a container and shaking the container. Conventional solutions may be messy (e.g., liquid, powder, and/or liquid-powder mix may exit (e.g., leak, splash out of) the container and/or may require increased user time and energy.

Many people blend beverages or sports drinks in containers (e.g., plastic vessels) by adding a powdered material to a liquid in the vessel and shaking the vessel to blend the powder into the liquid. However, this shaking creates an opportunity for the liquid to spill from the vessel, or the liquid to leak around the edge of the lid on the vessel. With vigorous agitation of the vessel containing the liquid and the powdered material, the liquid and/or powdered material can leak from the vessel as the vessel lid, or a leak from a cap sealing (e.g., a pour spout located on the vessel lid).

Some mixing vessels attempt to improve the mixing characteristics of the vessel by adding a mixer to the vessel. Thus, when the vessel lid is fastened to the vessel, and the vessel is shaken, the mixer in the vessel attempts to break up clumps of e.g., powdered material in the vessel to promote mixing. In some products, the mixer includes a round plastic piece with fins or blades extending out from a central point. In some instances, the mixer includes a round wire assembly, similar to a whisk. Even in mixing vessels with mixers located in the vessel with liquid, the shaking of the vessel may attempt to reduce either the force to agitate the liquid in the vessel to attempt to achieve threshold mixing or the time used to attempt to achieve threshold mixing of the liquid and powdered material. Leaks and spills are a common occurrence and shaking of the mixing vessels is difficult for people with weak grip strength (children or the elderly).

The present subject matter relates generally to a mixing or cleaning device. Mixing solid or powered materials with liquids may be used in food preparation and cleaning processes. In some conventional systems, a mixing device is mechanically coupled to a rotary electric motor to attempt to agitate the liquid and to attempt to stir the solid or powdered material into the liquid. In some conventional systems, the solid or powdered material is mixed into the liquid to attempt to promote the rate at which the material dissolves in the liquid.

In some conventional solutions, two counter-rotating mixing elements are placed in the liquid adjacent to each other to direct a flow of liquid propelled by each mixing element against the flow of liquid from the other mixing element to attempt to increase the rate of mixing for the solid or powdered material in the liquid.

For rotary mixers, the ability to rotate the mixing elements at high speed may attempt to enhance the ability of the rotary mixer to mix solid or powdered material into a liquid.

The present disclosure is associated with a magnetically-coupled blender bottle system.

A blender bottle system of the present disclosure includes a bottle structure forming an inner volume. Liquid is to be disposed in the inner volume.

The blender bottle system further includes a lid structure configured to releasably interface with the bottle structure. The lid structure includes a spout portion forming an opening. The blender bottle system further includes an actuation structure configured to be moved by a user relative to the bottle structure. The actuation structure includes one or more metallic components.

The blender bottle system further includes an agitator structure disposed in the bottle structure. The agitator structure and the actuation structure are magnetically attracted to each other. The agitator structure is configured to mix the liquid in the bottle structure responsive to the actuation structure being moved relative to the bottle structure.

In some embodiments, the lid structure includes a channel portion that forms a channel. The channel portion may include a closed bottom surface. The actuation structure may include an elongated portion configured to extend into the channel formed by the channel portion of the lid structure, the elongated portion comprising the one or more metallic components (e.g., magnetic components). The actuation structure may further include a handle portion configured to be used to move the elongated portion within the channel. The agitator structure may be configured to be disposed around the elongated portion. The actuation structure is to be raised and lowered by user interaction with the handle portion to raise and lower the agitator structure within the bottle structure to mix the liquid (e.g., with a powder).

In some embodiments, the actuation structure is configured to be disposed around the bottle structure and the agitator structure is configured to be substantially adjacent to an inner surface of the bottle structure. The actuation structure is to be raised and lowered by user interaction with an outer, lower, and/or upper surface of the actuation structure to raise and lower the agitator structure within the bottle structure to mix the liquid (e.g., with a powder).

The present disclosure may relate to a device (e.g., blender bottle system) that provides substantially thorough mixing of a liquid and a powdered material by using a magnetically coupled agitator structure (e.g., mixer) and actuation structure (e.g., handle) to agitate liquid and powdered material without shaking the bottle structure (e.g., mixing vessel). A magnetically coupled actuation structure (e.g., handle) and agitator structure (e.g., agitator) can mix a liquid and powdered material by [1] magnetically coupling the agitator structure (located in the bottle structure) and at least a portion of the actuation structure (separated from the liquid) and pumping the actuation structure (e.g., handle portion, etc.) up and down along a major axis of the bottle structure without shaking the bottle structure. In some embodiments, the pumping action to mix the liquid and powdered material is done while holding the bottle structure in one hand and pumping the actuation structure (e.g., handle, agitator) with the other hand. In some embodiments, the chance of leaks is further reduced by placing the filled bottle structure, with the lid structure sealed thereto, against a table or rigid surface (e.g., substantially horizontal surface), and holding the bottle structure against the table or rigid surface by pressing down on the vessel lid while pumping the handle up and down to move the agitator within the vessel.

The systems, components, and methods of the present disclosure have advantages over conventional solutions. The blender bottle system of the present disclosure may have less leaking (e.g., no leaking) compared to conventional solutions. The blender bottle system of the present disclosure may more thoroughly mix liquids and one or more other materials (e.g., powders) than conventional solutions. The blender bottle system of the present disclosure may more quickly mix liquids and one or more other materials (e.g., powders) than conventional solutions. The blender bottle system of the present disclosure may have less waste of materials (e.g., liquids, powders, etc.) compared to conventional solutions. The blender bottle system may generate an improved liquid and/or mixture than conventional solutions.

The present disclosure also has the benefit of using magnets with liquid (e.g., water, milk, mixtures, etc.) to provide a better liquid than conventional solutions. Water (H₂O) is made of bonded hydrogen and oxygen. Typically, H₂O groups together in clusters of molecules (e.g., 10-12 molecules). These clusters are held together by surface tension. The use of magnets by the present disclosure may affect this surface tension, breaking up the clusters of molecules into smaller clusters (e.g., clusters of 6-7 molecules). Magnets of the present disclosure may create a magnetic field that spreads the de-clustering to all groups of molecules that pass within the field. The one or more magnets of the present disclosure may de-cluster the water molecules and ionize the water molecules to be more alkaline. This may provide improved hydration (e.g., magnets make water “wetter” by breaking down the H₂O cluster size, smaller molecules are readily absorbed by the body allowing to hydrate quicker and more thoroughly). This also may provide better bio-availability (e.g., smaller molecule size and easy absorption is called “bioavailability,” this is also handy for absorbing whatever healthy nutrients the fluid is carrying).

Magnetizing liquid and magnetized liquid may refer to liquid having been subjected to a magnetic field which has changed certain properties of that liquid.

Magnets of the blender bottle system of the present disclosure may provide a magnetized water which is a more alkaline water and which may raise the pH of a user's body to better allow the body to get rid of toxins compared to conventional solutions. Bio-magnetized water of the blender bottle system of the present disclosure may be energy-building, activating, cleansing, and detoxifying.

The blender bottle system of the present disclosure may provide magnetized liquids (e.g., bi-polar magnetized liquids treated with both North and South poles) and may better alleviate ailments (e.g., mastitis, colds, coughs, bronchitis, fever, etc.), regularize women's menses, reduce tiredness in daily activities, reduce problems (e.g., digestive, urinary, nervous), reduce pains, reduce swellings, reduce painful urination, improve weight control (e.g., an adjutant to a correct diet, improves metabolic activity, burning excessive fatty tissue), unclog arteries and veins of deposits of cholesterol and salts, normalize the circulatory system, increase bone density and bone mineral content, reduce diabetic kidney damage, reduce blood sugar, increase antioxidant defenses, normalize cholesterol and triglyceride levels, improve pancreatic structure and function, improve insulin levels, improve levels (e.g., blood sugar, insulin, hemoglobin, etc.), decrease DNA damage, reduce tartar, improve oral health, prevent aging and fatigue (e.g., increase cell membrane permeability, unclog cholesterol and salts from arteries and veins to normalize circulatory systems), improve metabolism (e.g., controlling weight, burning excessive fatty tissue, improve metabolic activity), alleviates (e.g., colds, coughs, bronchitis, fever, arthritis pain), reduces blood pressure, aids in more quickly recovering from a stroke, and/or the like compared to conventional solutions. Magnetized liquid of the blender bottle system of the present disclosure may break up kidney and gallbladder stones into small enough particles to be passed through urine (e.g., without pain or danger to the patient). Magnetized water of the blender bottle system of the present disclosure may also prevent further formation of stones in the kidneys and gallbladder. Magnetized water of the blender bottle system of the present disclosure may be wetter and more penetrating than conventional solutions. This may further better assimilation of various nutrients and vitamins in the cells.

Although some embodiments of the present disclosure are described in relation to benefits of magnetizing water via blender bottle systems for human consumption, embodiments of the present disclosure may be used for benefits of magnetizing materials other than water (e.g., other liquids, mixtures, milk, juice, tea, coffee, liquid-type foods, oils, ointments, lotions, medical products, beauty products, facial creams, etc.) and/or for magnetizing materials (e.g., liquids) for uses other than human consumption (e.g., animal consumption, providing to plants, etc.).

Although some embodiments of the present disclosure are described in relation to blender bottle systems used to mix liquid and powder for human consumption, embodiments of the present disclosure may be used for containers other than blender bottles, for mixing materials other than liquid and powder, and/or for providing liquids and/or mixtures for other than human consumption.

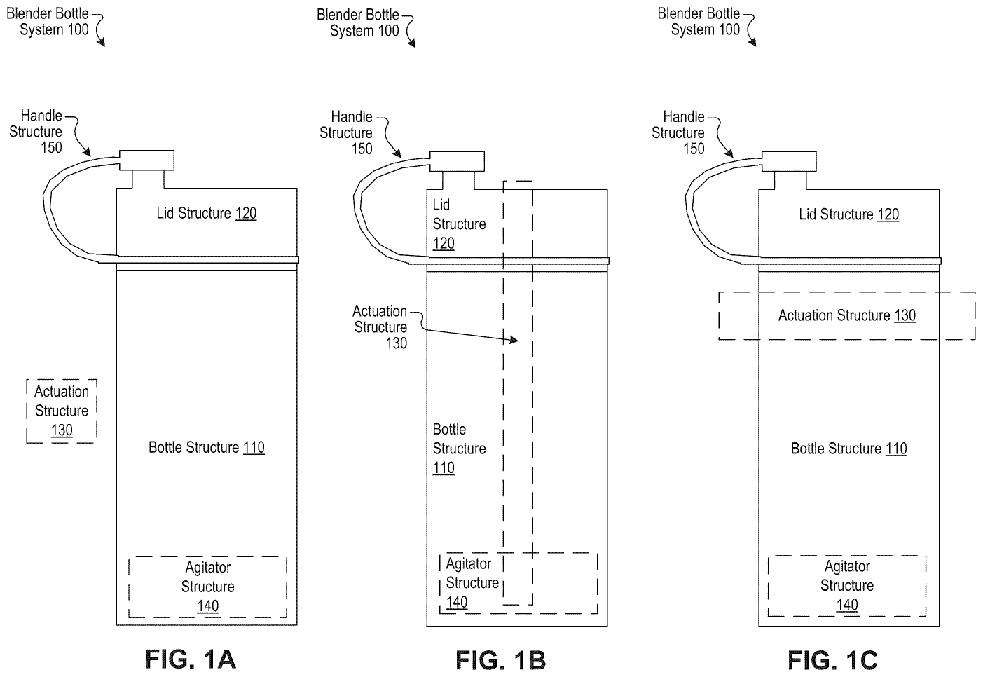

FIGS. 1A-C illustrate blender bottle systems 100, according to certain embodiments.

One or more of the components or features of FIGS. 1A-C, 2A-B, 3A-E, 4A-B, and/or 5A-E that have similar names and/or reference numbers may have similar functionality, materials, structure, and/or the like.

Referring to FIGS. 1A-C, a blender bottle system 100 may include a bottle structure 110, a lid structure 120, an actuation structure 130, an agitator structure 140, and/or a handle structure 150. In some embodiments, the blender bottle system 100 is all new components. In some embodiments, at least the actuator structure 130 and agitator structure 140 are added to an existing bottle structure 110 (e.g., and an existing lid structure 120 and/or handle structure 150).

The bottle structure 110 may form an inner volume. Liquid may be disposed in the inner volume. The bottle structure 110 may include an upper threaded portion.

The lid structure 120 may be configured to releasably interface with the bottle structure 110. The lid structure 120 may include a spout portion forming an opening. The lid structure 120 may include a lower threaded portion configured to interface with the upper threaded portion of the bottle structure 110 to prevent the liquid from exiting the blender bottle system 100 via an interface between the upper threaded portion and the lower threaded portion.

The actuation structure 130 may be configured to be moved by a user relative to the bottle structure 110. The actuation structure 130 may include one or more metallic components (e.g., one or more magnetic components).

The agitator structure 140 is configured to be disposed in the bottle structure 110 (e.g., in the liquid). The agitator structure 140 (e.g., containing one or more metallic components and/or one or more magnetic components where the north and south poles are on the sides of the agitator structure 140) and the actuation structure 130 may be magnetically attracted to each other. The agitator structure 140 may be configured to mix the liquid in the bottle structure 110 responsive to the actuation structure 130 being moved relative to the bottle structure 110.

The handle structure 150 may be a flexible plastic. A first portion of the handle structure may interface with an outer groove formed by an outer surface of the lid structure 120. A second portion 154 of the handle structure is configured to releasably interface with the spout portion and releasably cover the opening.

Referring to FIG. 1B, in some embodiments, the actuation structure 130 extends into the lid structure 120 and/or bottle structure 110. The actuation structure 130 and the agitator structure 140 are magnetically attracted to each other. As the actuation structure 130 is moved up and down in the lid structure 120 and/or bottle structure 110, the agitator structure 140 is moved up and down in the bottle structure 110 to mix the liquid in the bottle structure.

Referring to FIG. 1C, in some embodiments, the actuation structure 130 extends around the bottle structure 110. The actuation structure 130 and the agitator structure 140 are magnetically attracted to each other. As the actuation structure 130 is moved up and down around the bottle structure 110, the agitator structure 140 is moved up and down in the bottle structure 110 to mix the liquid in the bottle structure.

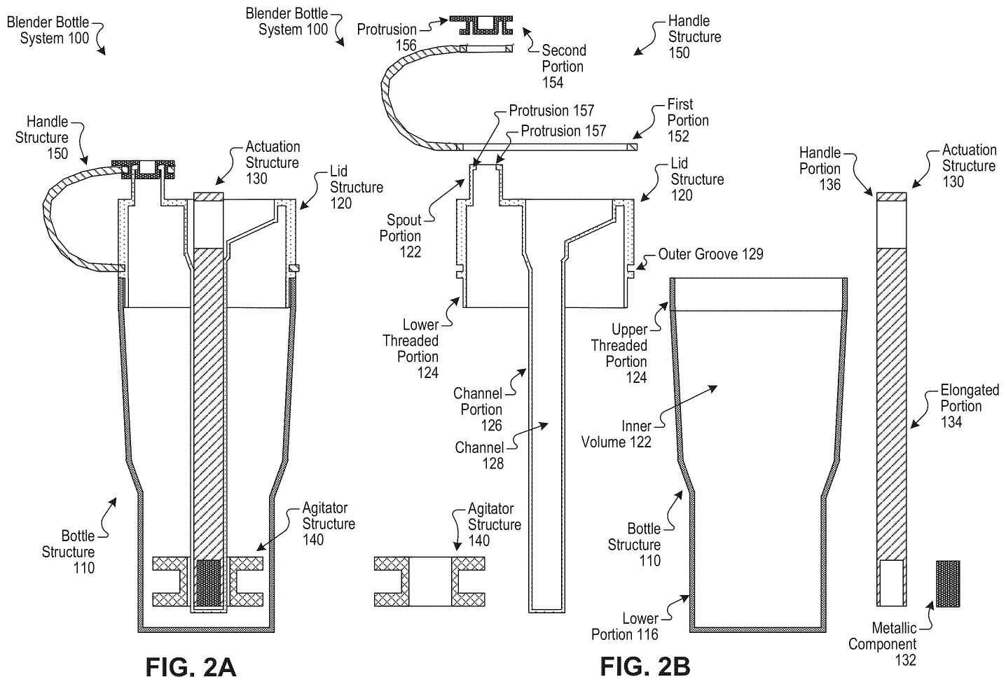

FIGS. 2A-B illustrate blender bottle systems 100, according to certain embodiments. FIG. 2A may illustrate an assembled blender bottle system 100 and FIG. 2B may illustrate components of a blender bottle system 100 (e.g., prior to assembly, after disassembly, etc.). One or more of the components or features of FIGS. 1A-C, 2A-B, 3A-E, 4A-B, and/or 5A-E that have similar names and/or reference numbers may have similar functionality, materials, structure, and/or the like.

Referring to FIGS. 2A-B, a blender bottle system 100 may include a bottle structure 110, a lid structure 120, an actuation structure 130, an agitator structure 140, and/or a handle structure 150.

The bottle structure 110 may form an inner volume 112. Liquid may be disposed in the inner volume 112. The bottle structure 110 may include an upper threaded portion 114. The bottle structure 110 may include a lower portion 116 that is configured to be disposed in a cup holder (e.g., automobile cup holder, furniture cup holder, etc.).

The lid structure 120 may be configured to releasably interface with the bottle structure 110 (e.g., via threading, via friction fit, via one or more clamps, etc.). The lid structure 120 may include a spout portion 122 forming an opening. The spout portion 122 may include one or more protrusions 157 to secure the second portion 154 of the handle structure 150 to the spout portion 122 (e.g., to prevent the second portion 154 from releasing from the spout portion 122 when the blender bottle system 100 is carried by the handle structure 150). In some embodiments, an inner surface of the spout portion 122 has one or more protrusions 157 that secure the second portion 154 of the handle structure 150 to the spout portion. In some embodiments, an inner surface of the second portion 154 of the handle structure 150 has one or more grooves that are configured to receive the one or more protrusions 157 of the spout portion 122.

In some embodiments, the spout portion 122 has an oval-shaped perimeter, an elliptical perimeter, or a circular perimeter.

The lid structure 120 may include a lower threaded portion 124 configured to interface with the upper threaded portion 114 of the bottle structure 110 to prevent the liquid from exiting the blender bottle system 100 via an interface between the upper threaded portion 124 and the lower threaded portion 114.

The lid structure 120 includes a channel portion 126 forming a channel 128. The channel portion 126 may include a closed bottom surface. There may be a space between the bottom surface of the bottle structure 110 (e.g., lower portion 116) and the closed bottom surface of the channel portion 126 to avoid securing powder between the bottom surface of the bottle structure 110 (e.g., lower portion 116) and the closed bottom surface of the channel portion 126. An outer surface of the lid structure 120 forms an outer groove 129. In some embodiments, the channel portion 126 has a substantially constant outer diameter from a first distal end of the channel portion 126 to a second distal end of the channel portion 126. The channel 128 formed by the channel portion 126 has a substantially constant channel diameter. In some embodiments, the channel portion 126 is configured to be disposed in the bottle structure 110 responsive to the lid structure 120 interfacing with the bottle structure 110 without the liquid entering the channel 128 formed by the channel portion 126.

In some embodiments, the lid structure 120 has a spout portion 122. In some embodiments, the lid structure 120 has a straw portion (e.g., an opening to receive or interface with a straw).

The actuation structure 130 may be configured to be moved by a user relative to the bottle structure 110. The actuation structure 130 may include one or more metallic components 132 (e.g., one or more magnetic components). In some embodiments, the north pole of the metallic component 132 (e.g., magnet) is on a first side of the metallic component 132 and the south pole of the metallic component 132 (e.g., magnet) is on a second side of the metallic component 132 (e.g., poles are not on top and bottom). In some embodiments, the one or more metallic components 132 are neodymium (neodymium magnets). In some embodiments, the elongated portion 134 (e.g., a bottom surface of the elongated portion 134) forms a recess and the metallic component 132 is secured in the recess (e.g., via adhesive, via friction fit, etc.).

The actuation structure 130 may include an elongated portion 134 configured to extend into the channel 128 formed by the channel portion 126 of the lid structure 120. The elongated portion 134 may include the one or more metallic components 132. The elongated portion 134 may form one or more recesses and the one or more metallic components 132 may be disposed in the one or more recesses. The actuation structure 130 may include a handle portion 136 configured to be used to move the elongated portion within the channel 128. In some embodiments, the handle portion 136 is configured to receive one or two fingers to move the actuation structure 130 relative to the bottle structure 110. In some embodiments, the handle portion 136 has a grip (e.g., fingernail grip) that is configured to be gripped to move the actuation structure 130 relative to the bottle structure 110.

In some embodiments, the elongated portion 134 has a cylindrical outer perimeter. In some embodiments, the elongated portion 134 has a crisscross outer perimeter. In some embodiments, the elongated portion 134 has a cross outer perimeter. In some embodiments, the elongated portion 134 has an x-shaped outer perimeter. In some embodiments, the handle portion 136 is rotatably coupled to the elongated portion 134. In some embodiments, an outer surface of the elongated portion 134 is helical (e.g., threaded) and an opening (e.g., formed by the lid structure 120) through which the elongated portion 134 passes is helical (e.g., threaded) to cause the elongated portion 134 (e.g., and agitator structure 140) to rotate as the elongated portion 134 is moved up and/or down.

In some embodiments, the channel portion 126 has an inner perimeter that substantially matches the outer perimeter of the elongated portion 134. In some embodiments, the channel portion 126 has a circular inner perimeter and the elongated portion 134 has a cross (e.g., crisscross, x-shaped, plus sign, etc.) outer perimeter.

In some embodiments, the channel portion 126 has a groove (e.g., keyway groove, recess) and the elongated portion 134 has a protrusion that inserts within the groove (e.g., to prevent the actuation structure 130 from rotating within the channel portion 126). In some embodiments, the channel portion 126 has a protrusion and the elongated portion 134 has a recess (e.g., groove) that is configured to receive the protrusion (e.g., to prevent the actuation structure 130 from rotating within the channel portion 126).

The agitator structure 140 is configured to be disposed in the bottle structure 110 (e.g., in the liquid). The agitator structure 140 (e.g., containing one or more metallic components and/or one or more magnetic components) and the actuation structure 130 may be magnetically attracted to each other. The agitator structure 140 may be configured to mix the liquid in the bottle structure 110 responsive to the actuation structure 130 being moved relative to the bottle structure 110. In some embodiments, at least a portion of the agitator structure 140 is magnetic. In some embodiments, the agitator structure 140 includes one or more protruding components configured to mix the liquid in the bottle structure 110. The agitator structure 140 may be configured to be disposed around the channel portion 126 of the lid structure 120.

In some embodiments, the agitator structure 140 includes flexible metal and/or flexible plastic. In some embodiments, the agitator structure 140 includes metal that is at least partially covered with plastic. In some embodiments, the agitator structure 140 is metal.

In some embodiments, the blender bottle system 100 has multiple (e.g., two) agitator structures 140. The actuation structure 130 (e.g., elongated portion 134) may include at least one metallic component 132 for each agitator structure 140.

The handle structure 150 includes a first portion 152 configured to interface with (e.g., be at least partially disposed in) the outer groove 129 formed by an outer surface of the lid structure 120 (e.g., the first portion may have a flat side surface configured to interface with the outer groove 129 that is flat). The handle structure 150 further includes a second portion 154 configured to releasably interface with the spout portion 122 and configured to releasably cover the opening. The second portion 154 may include a protrusion 156 configured to be lifted to release the second portion 154 from the spout portion 122. In some embodiments, the first portion 152 and the second portion 154 are part of the same component (e.g., flexible plastic).

The first portion 152 (e.g., flexible plastic) and the second portion 154 (e.g., softer rubber) may be separate components. In some embodiments, the first portion forms a first opening to receive the lid structure 120 and a second opening to receive the second portion 154.

In some embodiments, the liquid is to exit the blender bottle system 100 via the spout portion 122 responsive to the lid structure 120 interfacing with the bottle structure 110 and the second portion 154 of the handle structure 150 being released from the spout portion 122.

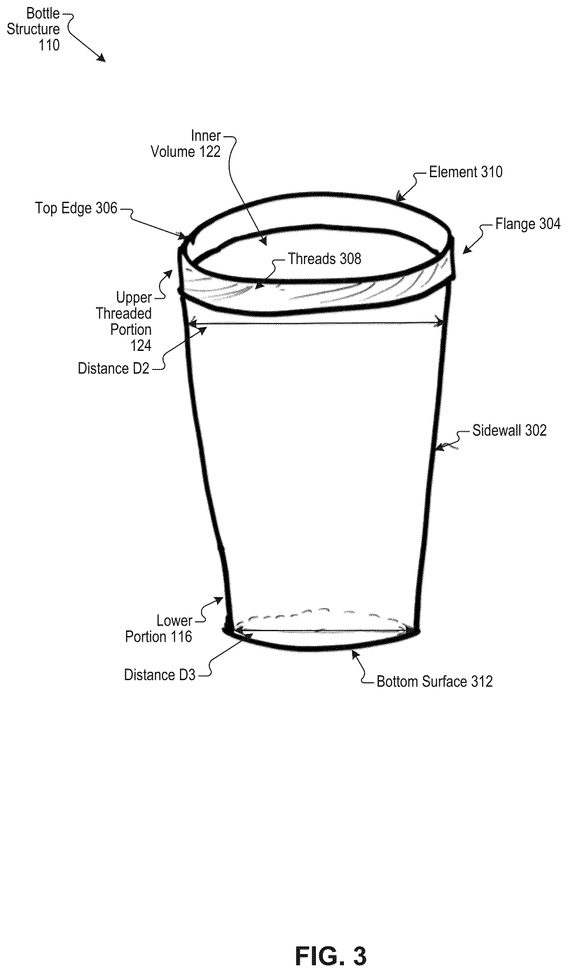

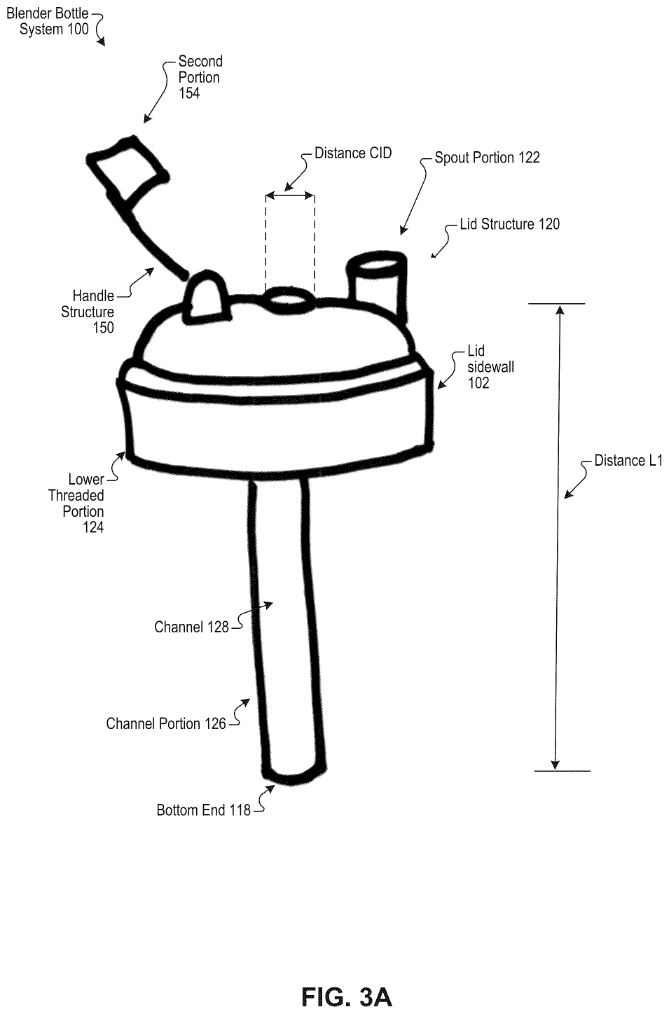

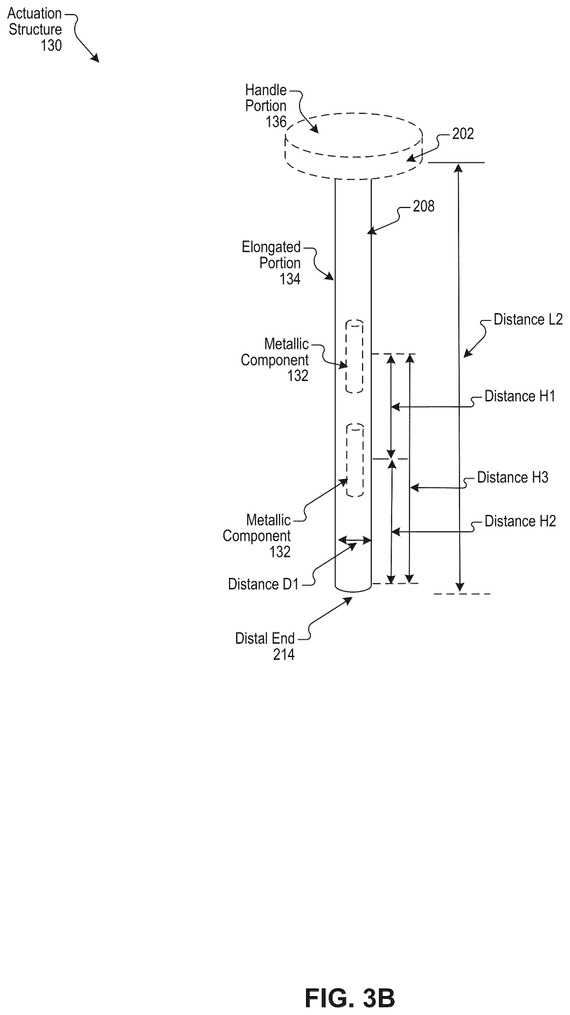

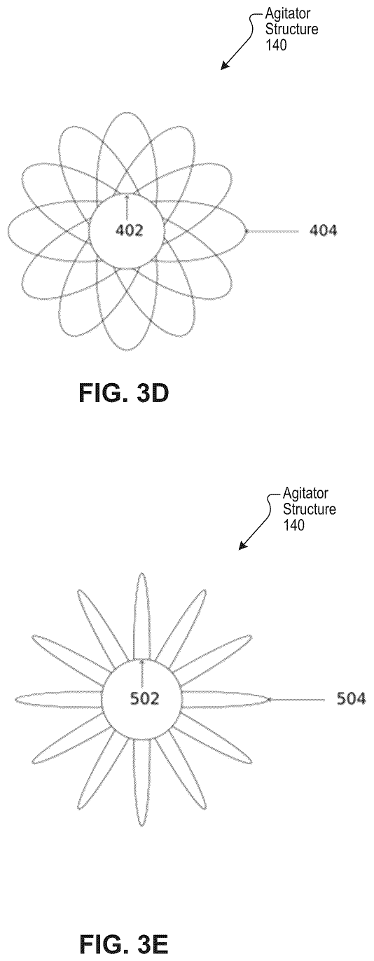

FIGS. 3A-E illustrate components of blender bottle systems 100, according to some embodiments. FIG. 3A illustrates the lid structure 120 and the handle structure 150. FIG. 3B illustrates the actuation structure 130. FIG. 3C illustrates the bottle structure 110. FIGS. 3D-E illustrate agitator structures 140. One or more of the components or features of FIGS. 1A-C, 2A-B, 3A-E, 4A-B, and/or 5A-E that have similar names and/or reference numbers may have similar functionality, materials, structure, and/or the like.

In some embodiments, the actuation structure 130 (e.g., handle) and agitator structure 140 magnetically couple to each other and that the actuation structure 130 (e.g., handle) and agitator structure 140, once magnetically coupled, move along a major axis of the blender bottle system 100 (e.g., mixing vessel), rather rotating around the major axis at a fixed position along the major axis.

The drawings depict one or more implementations of the claimed subject matter and are provided to demonstrate one or more examples of embodiments of the claimed subject matter. Persons having ordinary skill in the art will recognize that these embodiments are one of several possible embodiments, and are representative, and not limiting, in nature. In the drawings and specification, like reference numerals refer to the same or similar elements.

FIG. 3A illustrates the lid structure 120 and the handle structure 150. FIG. 3A illustrates (e.g., an upper portion of a blender bottle system 100 (e.g., mixing vessel) including the lid structure 120 (e.g., the vessel lid)) in accordance with some embodiments. The lid structure 120 (e.g., upper portion, the lid for the mixing vessel) includes a lid sidewall 102 with threads (not shown, on an interior or exterior surface of the lid sidewall 102) to hold the lid structure 120 to the bottle structure 110 (e.g., body) of the blender bottle system 100 (e.g., mixing vessel). Lid structure 120 (e.g., upper portion) includes a spout portion (e.g., pour spout) and a second portion 154 of handle structure 150 (e.g., pour spout lid). The second portion 154 of the handle structure 150 (e.g., pour spout lid) fastens, using the handle structure 150 (e.g., a holding strip) to lid structure 120 (e.g., via holding tabs extending up from a top surface of the lid structure 120, via a groove formed by the lid structure 120). In some embodiments, the lower surface of the lid sidewall 102 forms a compression fit with the bottle structure 110 (e.g., body of the lower portion of the mixing vessel).

Lid structure 120 (e.g., upper portion) includes a channel portion 126 which extends downward from the top surface of the lid structure 120 (e.g., upper portion), where the channel portion 126 has a channel length L1 and an inner diameter of the channel 128 formed by the channel portion 126 (not shown) CID. The upper end of the channel portion 126 forms an opening in the top surface of the lid structure 120 (e.g., upper portion) and is configured to receive an actuation structure 130 (e.g., actuation structure 130 including a handle portion) having at least one metallic component (e.g., magnet embedded therein). The opening at an end of the channel portion 126 proximal to the top surface is opposite the bottom end 118 of the channel portion 126. Bottom end 118 of the channel portion 126 is sealed to prevent passage of liquid or mixtures between the channel 128 and the bottle structure 110 (e.g., avoiding spilling responsive to shaking of the blender bottle system 100).

In some embodiments, the lid structure 120 (e.g., upper portion) and the handle structure 150 (e.g., pour spout lid) are manufactured by injection molding processes and assembled at a later time. By forming the lid structure 120 (e.g., upper portion) in a single injection molding process, the channel portion 126 forms an integral part of the lid structure 120 (e.g., upper portion) and there is no seam to leak where the channel portion 126 meets the top surface.

In some embodiments, the lid structure 120 (e.g., upper portion) fits onto a bottle structure 110 (e.g., lower portion) of a blender bottle system 100 (e.g., mixing vessel) by a compression fit as the lid structure 120 (e.g., upper portion) flexes when fit onto the bottle structure 110 (e.g., lower portion of the mixing vessel). In some embodiments, the lid structure 120 (e.g., upper portion) fits by compression alone, there may not be threads on the inner surface of the lid sidewall 102.

In some embodiments, the lid structure 120 (e.g., upper portion) includes a moldable material suitable for injection molding. In some embodiments, the moldable material includes one or more of high density polyethylene (HDPE), polypropylene (PP), nylon, acrylic, polystyrene (PS), silicone, or some other food-safe material suitable for storing food during food preparation or food handling.

FIG. 3B illustrates an actuation structure 130 (e.g., a mixing handle for a mixing vessel) of a blender bottle system 100, according to certain embodiments. Actuation structure 130 (e.g., mixing handle) includes a handle portion 136 (e.g., handle grip that has a flat top end and an underside). In some embodiments, underside of the handle portion 136 makes direct contact with top surface of lid structure 120 (e.g., upper portion). Actuation structure 130 (e.g., mixing handle 200) has an elongated portion 134 (e.g., a shaft) that has an outer diameter (e.g., shaft diameter) D1 and a shaft length L2. In some embodiments, shaft length L2 is larger than channel length L1. Embodiments where shaft length L2 is larger than channel length L1 are so configured to provide clearance for a person's fingers when gripping handle portion 136 during a mixing process. In some embodiments, shaft length L2 is shorter than channel length L1. Embodiments where shaft length L2 is shorter than channel length L1 are so configured to accommodate agitator structures 140 having a threshold vertical dimension along the major axis of the channel 128.

Actuation structure 130 (e.g., mixing handle) includes one or more metallic components 132 (e.g., one or more magnets, two magnets) embedded in the elongated portion 134 (e.g., shaft). In some embodiments, a midpoint of a first metallic component 132 is at a distance H1 from the distal end 214 of elongated portion 134. A midpoint of a second metallic component 132 may be at a distance H2 from the midpoint of the first metallic component 132 further from the distal end of elongated portion 134, or at a distance H3 from the distal end 214 of the elongated portion 134 (e.g., H1+H2=H3). In some embodiments, actuation structure 130 (e.g., mixing handle) has two magnets to promote easier mixing of a mixture of powdered material and liquid in a blender bottle system 100 (e.g., bottle structure 110, mixing vessel) because each of the two magnets can couple with an agitator structure 140 to allow the agitator structure 140 to mix with an upper portion of the liquid in the bottle structure 110 (e.g., mixing vessel) or a lower portion of the liquid in the bottle structure 110 (e.g., mixing vessel), while reducing the chance that the actuation structure 130 (e.g., mixing handle) will be accidentally pulled from the channel portion 126 during mixing process. In some embodiments, the actuation structure 130 (e.g., mixing handle) includes a single magnet. In some embodiments, the single magnet, or the lower magnet (e.g., closer to distal end 214) is at the end of the elongated portion 134 (e.g., shaft) to allow the magnet to magnetically couple to an agitator structure 140 resting at the bottom of a bottle structure 110 (e.g., mixing vessel lower portion).

According to some embodiments, the actuation structure 130 (e.g., mixing handle) includes a moldable material suitable for injection molding. In some embodiments, the moldable material includes one or more of high density polyethylene (HDPE), polypropylene (PP), nylon, acrylic, polystyrene (PS), silicone, or some other food-safe material suitable for storing food during food preparation or food handling. According to some embodiments, actuation structure 130 (e.g., mixing handle) includes a rigid material to reduce the flexibility as the actuation structure 130 (e.g., mixing handle) is used to agitate contents of a bottle structure 110. In some embodiments, the actuation structure 130 (e.g., mixing handle) includes, in addition to the magnets, a rigid core material to prevent flexing of the actuation structure 130 (e.g., handle portion 136), and the magnets and core material are coated by a second material which is food safe, as described above.

According to some embodiments, the handle portion 136 (e.g., handle grip) is a flat disk. In some embodiments, the handle portion 136 (e.g., handle grip) has a spherical shape. In some embodiments, the handle portion 136 (e.g., handle grip) includes a ring set perpendicular to top surface of lid structure 120 (e.g., upper portion), such that a finger can fit in the ring to raise and lower the actuation structure 130 (e.g., handle) in the channel 128 formed by the channel portion 126. In some embodiments, the handle portion 136 (e.g., handle grip) includes the same rigid core material into which the magnets are placed, and is coated with the second, food safe, material. In some embodiments, the handle portion 136 (e.g., handle grip) includes the same rigid core material into which the magnets are placed, and is not coated with the second, food safe, material. Because the actuation structure 130 (e.g., mixing handle) does not come into contact with the contents of a bottle structure 110 (e.g., mixing vessel) during mixing, the food-safe covering material is an optional element of the mixing handle.

FIG. 3C illustrates a bottle structure 110 (e.g., a lower portion) of a blender bottle system 100 (e.g., mixing vessel), according to certain embodiments. Bottle structure 110 (e.g., lower portion) includes a sidewall 302, a flange 304, a top edge 306, and threads 308. Threads 308 are configured to engage with threads of lid structure 120. In some embodiments, threads 308 are omitted from the flange 304 because the flange comprises a sealing lip (see optional element 310) configured to form a compression fit with a lower surface of a lid structure 120 (e.g., mixing vessel lid). Bottle structure 110 (e.g., lower portion) includes a bottom surface 312 with a smooth bottom suitable to stand on a table or counter during mixing. Bottle structure 110 (e.g., lower portion) has a first diameter D2 at the level of the flange 304 and a second diameter D3 at the bottom surface 312. In some embodiments, D2=D3 such that the sidewall 302 is perpendicular to the bottom surface 312. In some embodiments, the sidewall 302 is perpendicular to the bottom surface 312 so that the agitator structure 140 located in the bottle structure 110 has a constant clearance distance between the agitator structure 140 and the inner surface of sidewall 302 to provide enhanced mixing. In some embodiments, D3 is smaller than D2, such that the sidewall 302, measured from the flange to the bottom surface 312, is angled (e.g., tapered). In some embodiments, the sidewall is angled to provide a person with a range of outer diameters of the lower portion 300 to make holding the bottle structure 110 (e.g., lower portion) easier.

According to some embodiments, the bottle structure 110 (e.g., lower portion) includes a moldable material suitable for injection molding. In some embodiments, the moldable material includes one or more of high density polyethylene (HDPE), polypropylene (PP), nylon, acrylic, polystyrene (PS), silicone, or some other food-safe material suitable for storing food during food preparation or food handling. In some embodiments, bottle structure 110 (e.g., lower portion) includes glass.

FIG. 3D illustrates an agitator structure 140 of a blender bottle system 100 (e.g., a mixing vessel), according to certain embodiments. Agitator structure 140 includes a core 402 and mixing filaments 404 (e.g., protrusions). Core 402 may include an open cylinder of ferromagnetic material which is configured to magnetically couple to a magnet in an elongated portion 134 of an actuation structure 130 (see FIG. 3B). The mixing filaments 404 form loops that extend out from the outer surface of core 402 and cross adjacent filaments near the point of attachment of each mixing filament 404 with the outer surface of core 402.

In some embodiments, agitator structure 140 includes stainless steel and/or a food-safe material. In some embodiments, the mixing filaments take different shapes, including circles, ovals, or rectangles as they extend away from, and return to, core 402.

FIG. 3E illustrates an agitator structure 140 of a blender bottle system 100 (e.g., a mixing vessel), according to certain embodiments. Agitator structure 140 includes a core 402 and mixing fins 504. In some embodiments, mixing fins 504 include a same material as the core 402. In some embodiments, the mixing fins 504 include flat fins. In some embodiments, the mixing fins 504 include tilted fins. Core 402 includes a ferromagnetic material which can magnetically couple with at least one magnet in a shaft of a mixing handle introduced into the channel of the upper portion of the mixing vessel.

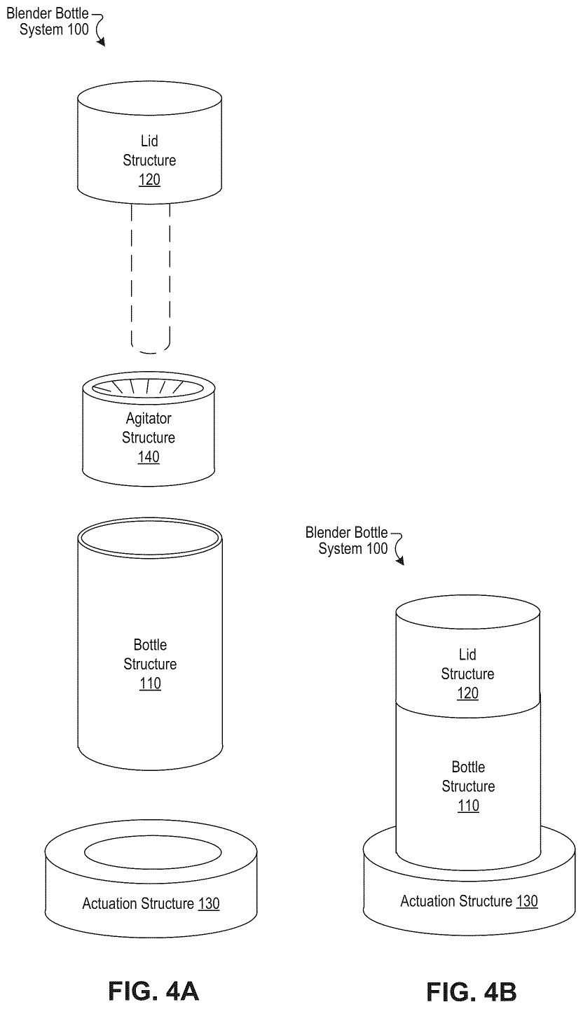

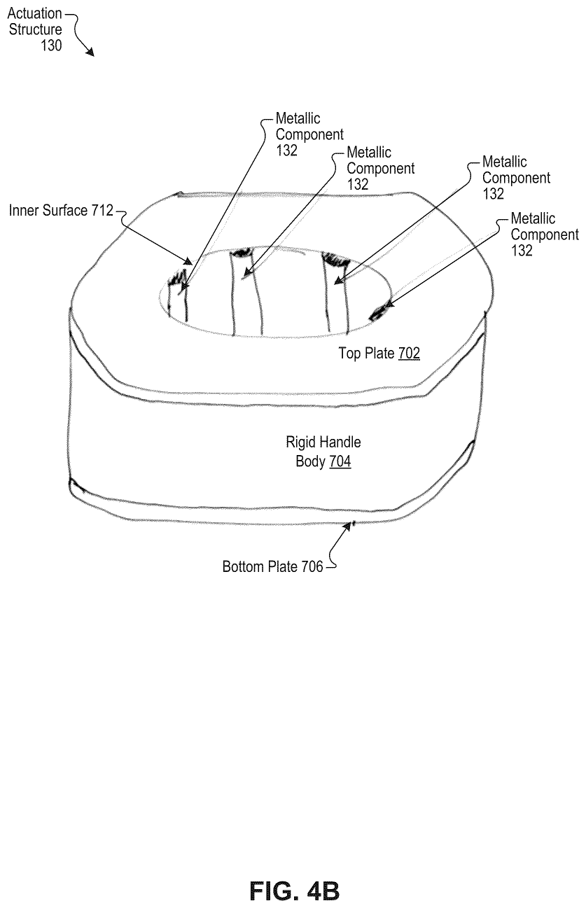

FIGS. 4A-C illustrate components of blender bottle systems 100, according to certain embodiments. FIG. 4A illustrates an exploded view of a blender bottle system 100, FIG. 4B illustrates an assembled view of a blender bottle system 100, and FIG. 4C illustrates an actuation structure 130 of a blender bottle system 100. One or more of the components or features of FIGS. 1A-C, 2A-B, 3A-E, 4A-B, and/or 5A-E that have similar names and/or reference numbers may have similar functionality, materials, structure, and/or the like.

Referring to FIGS. 4A-B, blender bottle system 100 includes a bottle structure 110, a lid structure 120, an actuator structure 130, and an agitator structure 140.

Agitator structure 140 may fit around the outer surface of a central shaft of the lid structure 120. Agitator structure 140 may include a ferromagnetic material which is coupled to an actuation structure 130 (e.g., handle) positioned outside the bottle structure 110 to mix the liquid in the bottle structure 110 by moving agitator structure 140 up and down in the bottle structure 110 as the actuation structure 130 is moved along the height of the bottle structure 110. Agitator structure 140 may include an open cylinder having a plurality of protrusions (e.g., filaments) located on an interior surface of the open cylinder. Protrusions (e.g., filaments) are configured to mix the liquid in the bottle structure 110. In some embodiments, the protrusions are metallic filaments which mix the liquid. In some embodiments, the protrusions are plastic and/or polymeric filaments which mix the liquid.

In some embodiments, the protrusions (e.g., filaments) have a length greater than the distance between the inner surface of the agitator structure 140 and the outer surface of the shaft of the lid structure 120. Thus, the protrusions (e.g., filaments) of an agitator structure 140 may be used to mix material (e.g., powder) on the shaft of the lid structure 120.

FIG. 4C illustrates an actuation structure 130 (e.g., magnetic handle) of a blender bottle system 100, in accordance with some embodiments. Actuation structure 130 (e.g., magnetic handle, handle) includes a rigid handle body 704 with a top plate 702 and a bottom plate 706. Actuation structure 130 (e.g., magnetic handle) further includes an inner surface 712 which extends from the top plate 702 to the bottom plate 706, and having a large enough diameter to allow the actuation structure 130 (e.g., handle) to fit around a bottle structure 110. In some embodiments, the inner surface 712 extends around a cylindrical opening, a square opening, or a hexagonal opening. In some embodiments, the shape of the opening described by inner surface 712 corresponds to the outer profile of an outer wall of a filter assembly.

In some embodiments, top plate 702 and bottom plate 706 are fastened to the rigid handle body 704 by screws or other fasteners. In some embodiments, top plate 702 and bottom plate 706 fasten to rigid handle body 704 by flexible snap connectors. In some embodiments, the top plate 702 and bottom plate 706 fasten to the rigid handle body by screwing the top and bottom plate to the body and holding on by friction. In some embodiments, actuation structure 130 (e.g., magnetic handle) is a single piece of material with no top plate or no bottom plate. In some embodiments, the rigid handle body 704 has cylindrical holes therein into which metallic components 132 (e.g., magnets) are inserted. In some embodiments the rigid handle body 704 has fully cylindrical holes extending into the handle body from a top or bottom side of the rigid handle body. In some embodiments, the rigid handle body has recesses in inner surface 712, configured to hold metallic components 132 (e.g., magnets) placed therein. In some embodiments, a protective sleeve (not shown) is placed on inner surface 712 to hold metallic components 132 (e.g., magnets) in the recesses in inner surface 712 and to protect the bottle structure from being scratched or damaged by the metallic components 132 (e.g., magnets) or other parts of the actuation structure 130 (e.g., magnetic handle) which are proximate (e.g., make contact with) the outer surface of the bottle structure 110.

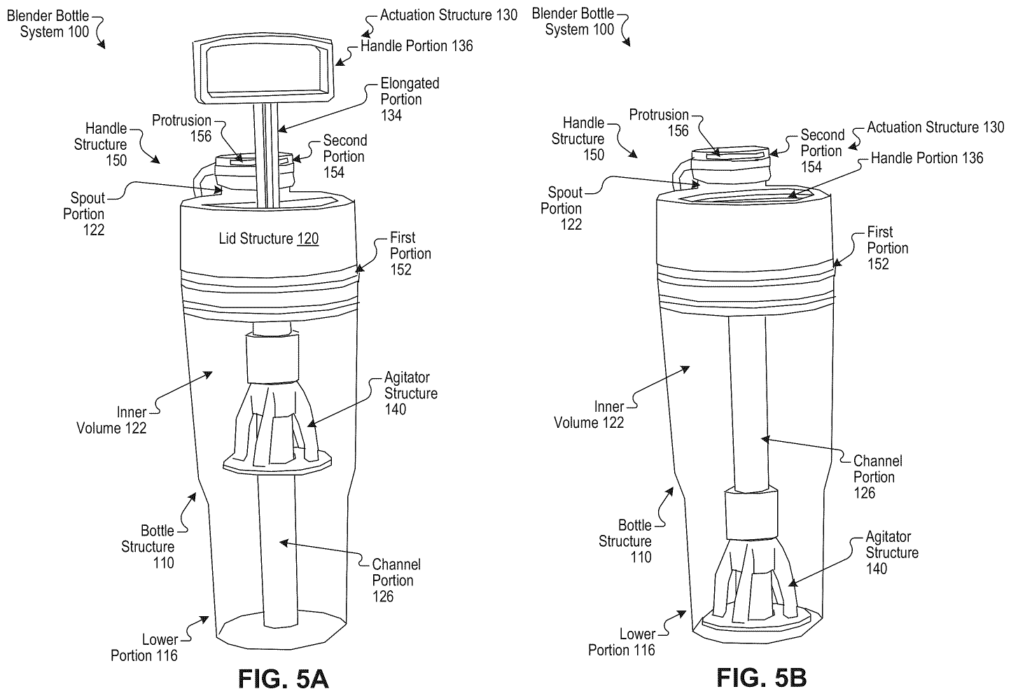

FIGS. 5A-B illustrate perspective views of blender bottle systems 100, according to certain embodiments. FIG. 5A illustrates the actuation structure 130 and agitator structure 140 in a raised position and FIG. 5B illustrates the actuation structure 130 and agitator structure 140 in a lowered position. One or more of the components or features of FIGS. 1A-C, 2A-B, 3A-E, 4A-B, and/or 5A-E that have similar names and/or reference numbers may have similar functionality, materials, structure, and/or the like.

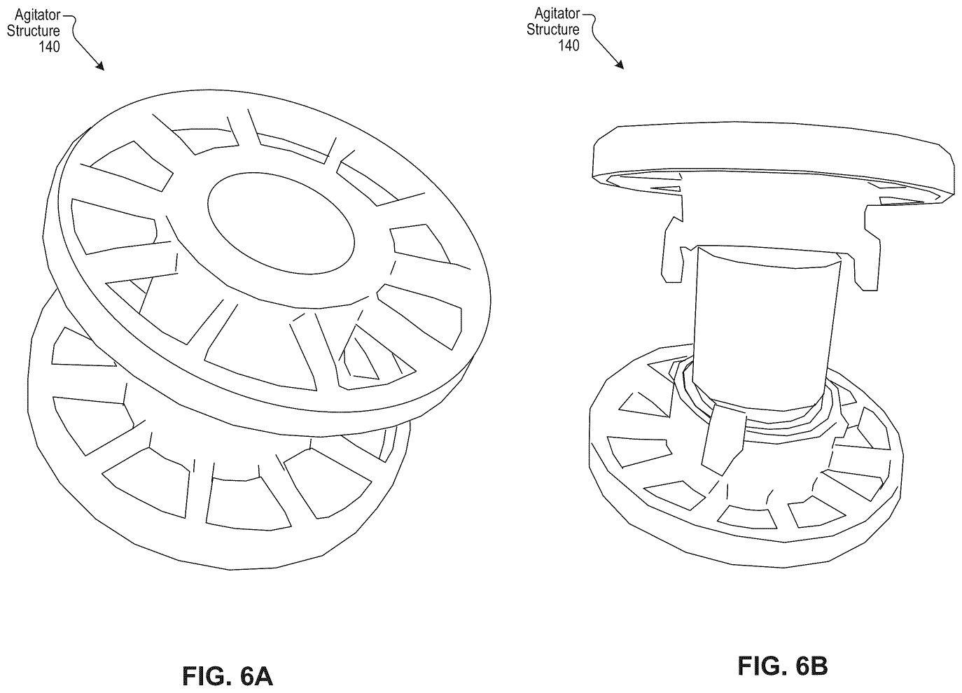

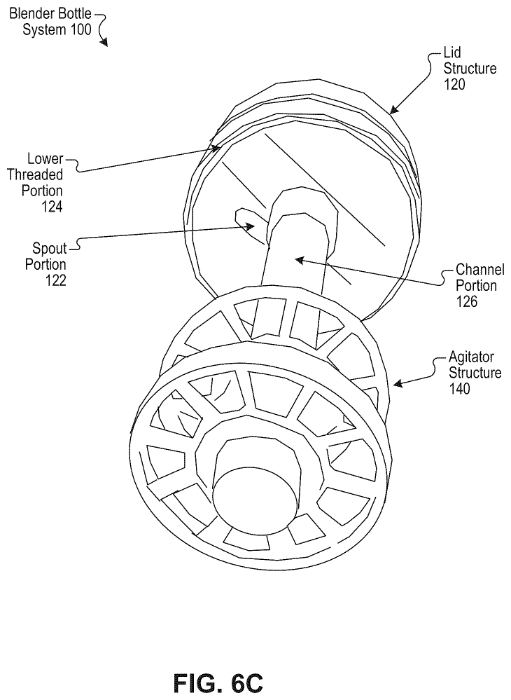

FIGS. 6A-C illustrate agitator structures 140 of blender bottle systems 100 (e.g., mixing vessels), in accordance with some embodiments. The agitator structure 140 may include a metal component (e.g., magnetic component) disposed inside of a plastic shell. The agitator structure 140 may fit around a channel portion 126 of a lid structure 120. The agitator structure 140 may move up and down the channel portion 126 to mix the liquid (e.g., and powder) responsive to the actuation structure 130 moving up and down within the channel 128 formed by the channel portion 126.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example' or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

Throughout the descriptions provided herein, a single identifying numeral is used to describe an element of the described embodiments of the claimed subject matter and is intended to represent similar elements found in similar embodiments.

It should be noted that various changes and modifications to the presently preferred embodiments described herein will be apparent to persons who are skilled in the art. Such changes and modifications are within the scope of the subject matter described herein, and do not deviate from the spirit and scope of the present disclosure and do not diminish the benefits derived therefrom.

What is claimed is:

1. A blender bottle system comprising:
a bottle structure forming an inner volume, wherein liquid is to be disposed in the inner volume, wherein the bottle structure comprises an upper threaded portion;
a lid structure configured to releasably interface with the bottle structure, the lid structure comprising a spout portion forming an opening, wherein the lid structure comprises a lower threaded portion configured to interface with the upper threaded portion of the bottle structure to prevent the liquid from exiting the blender bottle system via an interface between the upper threaded portion and the lower threaded portion;
an actuation structure configured to be moved by a user relative to the bottle structure, the actuation structure comprising one or more metallic components; and
an agitator structure disposed in the bottle structure, the agitator structure and the actuation structure being magnetically attracted to each other, the agitator structure being configured to mix the liquid in the bottle structure responsive to the actuation structure being moved relative to the bottle structure.

2. The blender bottle system of claim 1, wherein the lid structure comprises a channel portion forming a channel, the channel portion comprising a closed bottom surface, wherein the actuation structure comprises:
an elongated portion configured to extend into the channel formed by the channel portion of the lid structure, the elongated portion comprising the one or more metallic components; and
a handle portion configured to be used to move the elongated portion within the channel.

3. The blender bottle system of claim 2, wherein the agitator structure is configured to be disposed around the elongated portion.

4. The blender bottle system of claim 1, wherein the actuation structure is configured to be disposed around the bottle structure, wherein the agitator structure is configured to be substantially adjacent to an inner surface of the bottle structure.

5. The blender bottle system of claim 1, wherein the one or more metallic components are magnetic components.

6. The blender bottle system of claim 1, wherein at least a portion of the agitator structure is magnetic.

7. The blender bottle system of claim 1, wherein the agitator structure comprises one or more protruding components configured to mix the liquid in the bottle structure.

8. A blender bottle system comprising:
a bottle structure forming an inner volume, wherein liquid is to be disposed in the inner volume;
a lid structure configured to releasably interface with the bottle structure, the lid structure comprising: a channel portion forming a channel and comprising a closed bottom surface; and a spout portion forming an opening;
an actuation structure comprising: an elongated portion configured to extend into the channel formed by the channel portion of the lid structure, the elongated portion comprising one or more metallic components; and a handle portion configured to be used to move the elongated portion within the channel; and
an agitator structure configured to be disposed around the channel portion of the lid structure, the agitator structure and the one or more metallic components being magnetically attracted to each other, the agitator structure being configured to mix the liquid in the bottle structure responsive to the elongated portion being moved at least partially within the channel.

9. The blender bottle system of claim 8, wherein:
the bottle structure comprises an upper threaded portion; and
the lid structure comprises a lower threaded portion configured to interface with the upper threaded portion to prevent the liquid from exiting the blender bottle system via an interface between the upper threaded portion and the lower threaded portion.

10. The blender bottle system of claim 8, wherein:
the channel portion has a substantially constant outer diameter from a first distal end of the channel portion to a second distal end of the channel portion; and
the channel formed by the channel portion has a substantially constant channel diameter.

11. The blender bottle system of claim 8, wherein the channel portion is configured to be disposed in the bottle structure responsive to the lid structure interfacing with the bottle structure without the liquid entering the channel formed by the channel portion.

12. The blender bottle system of claim 8 further comprising a handle structure comprising:
a first portion configured to interface with an outer groove formed by an outer surface of the lid structure; and
a second portion configured to releasably interface with the spout portion and configured to releasably cover the opening, the second portion comprising a protrusion configured to be lifted to release the second portion from the spout portion.

13. The blender bottle system of claim 12, wherein the liquid is to exit the blender bottle system via the spout portion responsive to the lid structure interfacing with the bottle structure and the second portion of the handle structure being released from the spout portion.

14. The blender bottle system of claim 8, wherein the bottle structure comprises a lower portion configured to fit in an automobile cup holder.

15. A blender bottle system comprising:
a bottle structure forming an inner volume, wherein liquid is to be disposed in the inner volume;
a lid structure configured to releasably interface with the bottle structure, the lid structure comprising a spout portion forming an opening;
an actuation structure configured to be disposed around the bottle structure; and.
an agitator structure configured to be substantially adjacent to an inner surface of the bottle structure, the actuation structure and the agitator structure being magnetically attracted to each other, the agitator structure being configured to mix the liquid in the bottle structure responsive to the actuation structure being moved relative to the bottle structure.

16. The blender bottle system of claim 15, wherein at least one of the bottle structure or the lid structure comprises a corresponding protruding portion configured to prevent the actuation structure from moving further in a corresponding direction relative to the bottle structure.

17. The blender bottle system of claim 15 further comprising a central shaft configured to center the agitator structure relative to the inner volume.

18. The blender bottle system of claim 15, wherein the actuation structure comprises one or more magnetic components.

19. The blender bottle system of claim 15, wherein at least a portion of the agitator structure is magnetic.

20. The blender bottle system of claim 15, wherein the agitator structure comprises one or more protruding components configured to mix the liquid in the bottle structure.
